(19) United States
(12) Patent Application Publication
(10) Pub. No.: US 2020/0003672 A1
(43) Pub. Date: Jan. 2, 2020

(54) CHARGE GENERATION ELEMENT AND FINE-PARTICLE COUNT DETECTOR

(71) Applicant: NGK INSULATORS, LTD., Nagoya-City (JP)

(72) Inventors: Hidemasa OKUMURA, Nagoya-City (JP); Kazuyuki MIZUNO, Nagoya-City (JP); Keiichi KANNO, Nagoya-City (JP)

(73) Assignee: NGK INSULATORS, LTD., Nagoya-City (JP)

(21) Appl. No.: 16/564,163

(22) Filed: Sep. 9, 2019

Related U.S. Application Data
(63) Continuation of application No. PCT/JP2018/006437, filed on Feb. 22, 2018.

(30) Foreign Application Priority Data
Mar. 10, 2017 (JP) 2017-045635

(51) Int. Cl. G01N 15/06

(52) U.S. Cl. CPC G01N 15/0656

(57) ABSTRACT

A charge generation element has a discharge electrode on a front surface of a dielectric layer and ground electrodes on a rear surface, and generates electric charge as a result of a discharge upon application of a voltage between the discharge electrode and the ground electrodes. The discharge electrode has a flat base surface and a bulging surface having a shape bulging from the base surface, and the angle θ between the base surface and the bulging surface is from 5° to 45° at an edge E of the discharge electrode.

### BACKGROUND OF THE INVENTION

### 1. Field of the Invention

The present invention relates to a charge generation element and a fine-particle count detector.

### 2. Description of the Related Art

As a fine-particle count detector, an apparatus is known in which ions are generated by corona discharge at a charge generation element, fine-particles in a measured gas are charged with the ions, the charged fine-particles are collected by a collection electrode, a count measurement device measures the number of fine-particles on the basis of the charge amount of the collected fine-particles (for example, see PTL 1). In addition, as a charge generation element, an element is known in which a discharge electrode and a ground electrode are provided so as to face each other with a dielectric layer therebetween (for example, see PTL 2).

### CITATION LIST

### Patent Literature

PTL 1: WO 2015/146456 A1

PTL 2: JP 2009-31606 A

### SUMMARY OF THE INVENTION

However, an end portion (a side) of the discharge electrode is formed at right angles with respect to the surface of the dielectric layer where the discharge electrode is provided, and thus an electric field is less likely to concentrate. In order to have an electric field strength that causes an electric discharge, an applied voltage needs to be high.

The present invention has been made to solve this problem, and a main object of the present invention is to lower the voltage between a discharge electrode and a ground electrode for generating electric charge.

A charge generation element of the present invention includes a discharge electrode on one surface of a dielectric layer, and a ground electrode on the other surface or in the inside of the dielectric layer, the charge generation element generating electric charge as a result of a discharge upon application of a voltage between the discharge electrode and the ground electrode, wherein the discharge electrode has a flat base surface and a bulging surface having a shape bulging from the base surface, and an angle θ between the base surface and bulging surface is from 5° to 45° at an edge of the discharge electrode.

In this charge generation element, the discharge electrode has a planar-shaped base surface and a bulging surface having a shape bulging from the base surface, and the angle θ between the base surface and the bulging surface is from 5° to 45° (preferably from 10° to 30°) at the edge of the discharge electrode. That is, the discharge electrode becomes gradually thinner towards its edge. Thus, compared with a case where the angle θ is 90°, an electric field is likely to concentrate at the edge of the discharge electrode. Thus, the voltage between the discharge electrode and the ground electrode for generating electric charge can be lowered.

Note that herein “electric charge” includes ions in addition to positive charge and negative charge. In addition, the “shape bulging from the base surface” may be a shape bulging toward the inside of the dielectric layer from the base surface, or may also be a shape bulging from the base surface toward the outside of the dielectric layer.

In the charge generation element according to the present invention, the dielectric layer is made of a ceramic material, and the discharge electrode and the dielectric layer may be bonded together by sintering or with an inorganic adhesive. As a result, higher heat resistance can be achieved than in a case where the discharge electrode and the dielectric layer are bonded using an organic material.

In the charge generation element according to the present invention, the base surface of the discharge electrode is flush with the one surface of the dielectric layer, and the bulging surface may bulge from the base surface toward the inside of the dielectric layer. As a result, foreign matters are less likely to accumulate than in a case where the bulging surface has a shape bulging from the base surface toward the outside of the dielectric layer. The base surface of this discharge electrode may be coated by an insulative protection layer. The base surface of the discharge electrode is flush with the one surface of the dielectric layer, and thus the protection layer can be evenly formed without generation of voids by, for example, printing.

In the charge generation element according to the present invention, the base surface of the discharge electrode is flush with the one surface of the dielectric layer, and the bulging surface may bulge from the base surface toward the outside of the dielectric layer. As a result, foreign matters are less likely to accumulate than in the case of a rectangular cross-section discharge electrode. The bulging surface of this discharge electrode may be coated by an insulative protection layer. The bulging surface of the discharge electrode is more gently sloped compared with a rectangular cross-section discharge electrode, and thus the protection layer can be formed relatively well by, for example, printing.

A fine-particle count detector according to the present invention includes any one of the above-described charge generation elements, the charge generation element adding electric charge to fine-particles in gas drawn into an air pipe, and a detection device that detects the number of fine-particles in the gas on the basis of a charge amount of fine-particles to which the electric charge is added or a charge amount that is not added to the fine-particles.

In this fine-particle count detector, using the above-described charge generation element, electric charge is added to fine-particles in gas drawn into the air pipe, and the number of fine-particles in the gas is detected on the basis of a charge amount of fine-particles to which the electric charge is added or a charge amount that is not added to the fine-particles. In the above-described charge generation element, the discharge electrode has the planar-shaped base surface and the bulging surface having a shape bulging from the base surface, and the angle θ between the base surface and the bulging surface is from 5° to 45° (preferably from 10° to 30°) at the edge of the discharge electrode. Thus, compared with a case where the angle is 90°, an electric field is likely to concentrate at the edge of the discharge electrode. Thus, the voltage between the discharge electrode and the ground electrode for generating electric charge can be lowered.

Note that “detects the number of fine-particles” includes a case where it is determined whether the number of fine-particles falls within a predetermined range of numerical values (for example, whether the number of fine-particles exceeds a predetermined threshold) in addition to a case where the number of fine-particles is measured.

The fine-particle count detector according to the present invention is used in, for example, an air environmental research, an indoor environmental research, a pollution research, and burning particle measurement, particle generation environmental monitoring, and particle synthesis environmental monitoring for cars and the like.

### BRIEF DESCRIPTION OF THE DRAWINGS

FIG. 1 is a plan view of a charge generation element 20.

FIG. 2 is a cross section taken along line A-A.

FIG. 3 is a cross section of a charge generation element 120.

FIG. 4 is a cross section of a charge generation element 220.

FIG. 5 is a cross section of a charge generation element 320.

FIG. 6 is a cross section of a modification of the charge generation element 320.

FIG. 7 is a cross section of a charge generation element 420.

FIG. 8 is a cross section of a fine-particle count detector 10.

FIG. 9 is a cross section of a charge generation element 520.

### DETAILED DESCRIPTION OF THE INVENTION

### First Embodiment

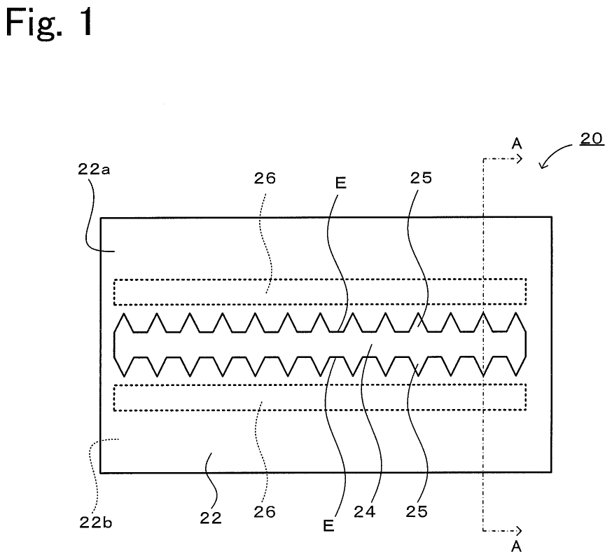

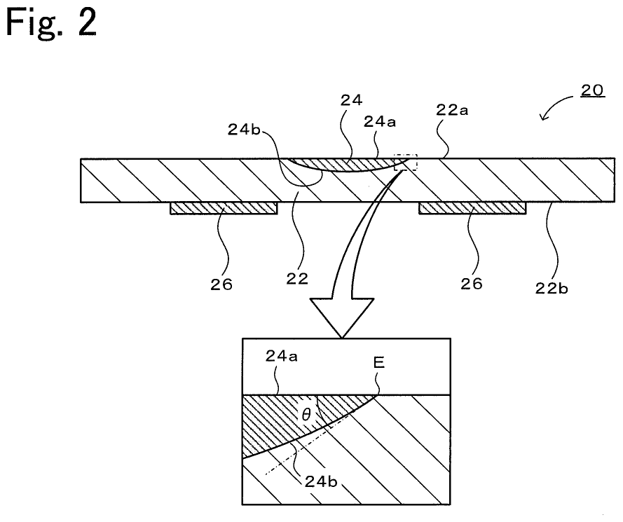

A preferred embodiment of the present invention will be described below with reference to the drawings. FIG. 1 is a plan view of a charge generation element 20, and FIG. 2 is a cross section taken along line A-A of FIG. 1 (with an enlarged view of a portion surrounded by a square indicated by alternate long and short dashed lines).

The charge generation element 20 according to the present embodiment has a discharge electrode 24 on a front surface 22a of a dielectric layer 22, and ground electrodes 26 on a rear surface 22b of the dielectric layer 22.

The dielectric layer 22 is a flat plate-like layer made of a dielectric. Materials for the dielectric layer 22 are not specially limited. For example, ceramic materials such as alumina, aluminum nitride, silicon nitride, silicon carbide, mullite, zirconia, titania, and magnesia are taken as an example.

As illustrated in FIG. 1, the discharge electrode 24 is formed to have, when viewed from the top surface, a shape obtained by providing a plurality of triangle-shaped protrusions 25 at two long sides of a rectangle, the sides facing each other. The discharge electrode 24 is bonded to the front surface 22a of the dielectric layer 22 by sintering. As illustrated in FIG. 2, the discharge electrode 24 has a flat base surface 24a and a bulging surface 24b having a shape bulging from the base surface 24a in a cross section taken along the thickness direction. The base surface 24a is flush with the front surface 22a of the dielectric layer 22. The bulging surface 24b has a shape bulging from the base surface 24a toward the inside of the dielectric layer 22. At an edge E (that is, an outer peripheral edge) of the discharge electrode 24, the angle θ between the base surface 24a and the bulging surface 24b is from 5° to 45° and preferably from 10° to 30°. Materials for the discharge electrode 24 are not specially limited as long as the materials do not melt, scatter, and deform due to a discharge. For example, platinum, tungsten, silver, palladium, titanium, chromium, iron, cobalt, nickel, niobium, molybdenum, tantalum, iridium, gold, or an alloy of these materials is taken as an example.

As illustrated in FIG. 1, when viewed perspectively from the top surface, the ground electrodes 26 have a rectangular shape. One ground electrode 26 is provided on the side where one of the long sides of the discharge electrode 24 is provided and another ground electrode 26 is provided on the side where the other one of the long sides is provided. The ground electrodes 26 are bonded to the rear surface 22b of the dielectric layer 22 by sintering. As illustrated in FIG. 2, the ground electrodes 26 have a rectangular cross section when taken along the thickness direction. For the ground electrodes 26, materials substantially the same as those for the discharge electrode 24 may be used.

Next, examples of the use of the charge generation element 20 will be described. The voltage of an unillustrated discharge power supply is applied to the charge generation element 20 such that a potential difference occurs between the discharge electrode 24 and the ground electrodes 26. A discharge then occurs near the discharge electrode 24 on the basis of the potential difference. This discharge ionizes gas that is present around the discharge electrode 24, and electric charge is generated. In this case, since the protrusions 25, which protrude in the direction along the front surface of the dielectric layer 22, are provided on the long sides of the discharge electrode 24, an electric field is likely to concentrate at the tips of the protrusions 25. In addition, the cross section of the discharge electrode 24 becomes thinner toward the edge E, and the angle θ between the base surface 24a and the bulging surface 24b is from 5° to 45°. Thus, compared with a case where a discharge electrode has a rectangular cross section (the angle θ is 90°), an electric field is likely to concentrate at the edge E of the discharge electrode 24.

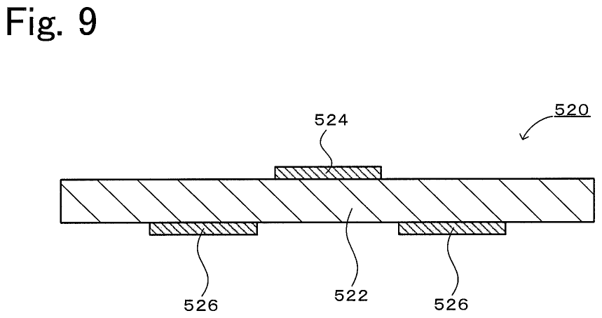

In the charge generation element 20 described above, since the discharge electrode 24 becomes thinner toward the edge E, compared with a case where the angle θ is 90°, an electric field is likely to concentrate at the edge E of the discharge electrode 24. Thus, compared with a conventional charge generation element, the voltage between the discharge electrode 24 and the ground electrodes 26 for generating electric charge can be lowered. Note that, as the conventional charge generation element, for example as illustrated in FIG. 9, a charge generation element 520, which has a rectangular cross-section discharge electrode 524 on the front surface of a dielectric layer 522 and rectangular cross-section ground electrodes 526 on the rear surface of the dielectric layer 522, is taken for an example.

In addition, the dielectric layer 22 is composed of a ceramic material, and the discharge electrode 24 and the ground electrodes 26 are bonded to the dielectric layer 22 by sintering. Thus, higher heat resistance can be achieved than in a case where the electrodes 24 and 26 are bonded using an organic material.

Furthermore, the base surface 24a, which is exposed to the outside, of the discharge electrode 24 is flush with the front surface 22a of the dielectric layer 22, and thus foreign matters are less likely to accumulate than in a case where the surface exposed to the outside bulges outward from the front surface 22a of the dielectric layer 22.

Note that the present invention is not limited to the above-described embodiment at all. Needless to say, the present invention can be carried out in various modes without departing from the technical scope of the present invention.

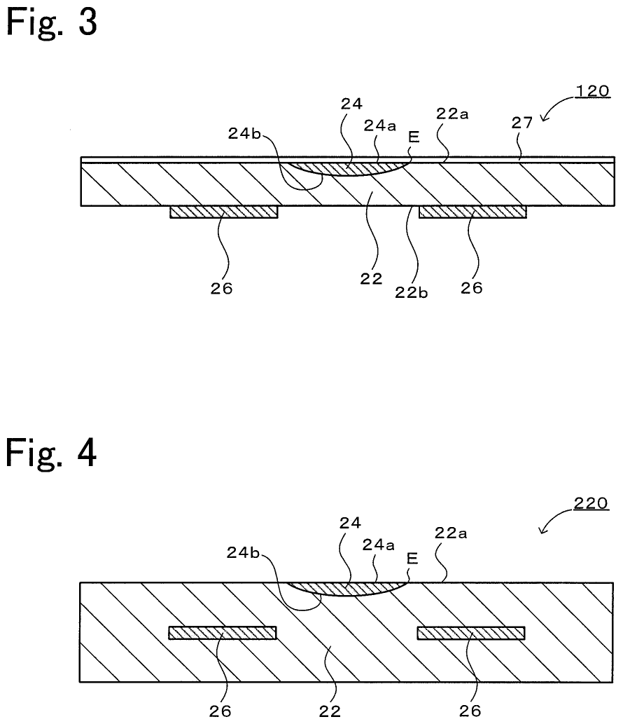

For example, in the above-described embodiment, as in the case of a charge generation element 120 illustrated in FIG. 3, the front surface 22a of the dielectric layer 22 and the base surface 24a of the discharge electrode 24 may be covered by an insulative protection layer 27. In FIG. 3, the same structural elements as those in the above-described embodiment are denoted by the same reference numerals. The protection layer 27 prevents damage and oxidation of the discharge electrode 24 due to discharge deterioration, and also plays a role to prevent the dielectric layer 22 from taking up moisture. The base surface 24a of the discharge electrode 24 is flush with the front surface 22a of the dielectric layer 22, and thus the protection layer 27 can be evenly formed without generation of voids by, for example, printing.

In the above-described embodiment, as in the case of a charge generation element 220 illustrated in FIG. 4, the ground electrodes 26 may be embedded in the dielectric layer 22. In FIG. 4, the same structural elements as those in the above-described embodiment are denoted by the same reference numerals. In this ways, also, substantially the same advantageous effects as those of the above-described embodiment can be obtained.

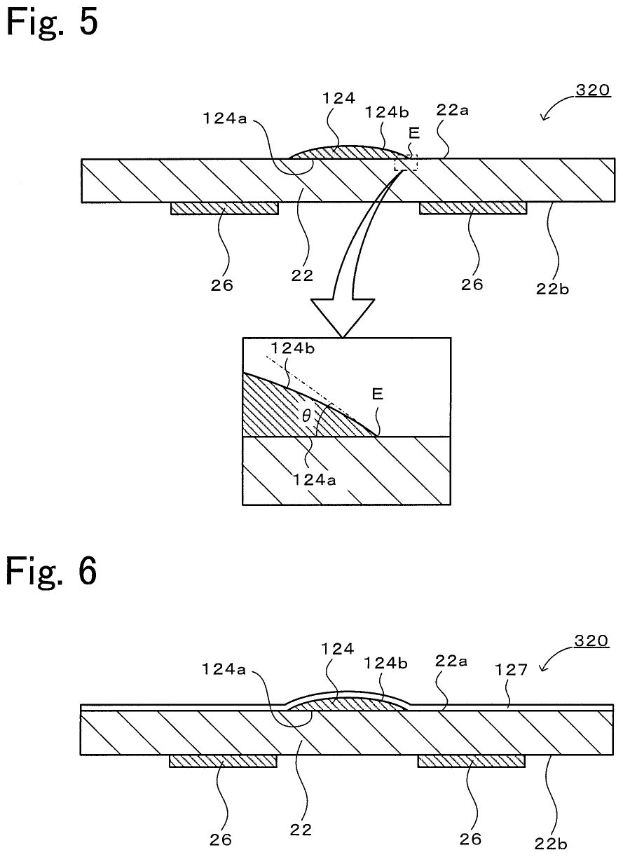

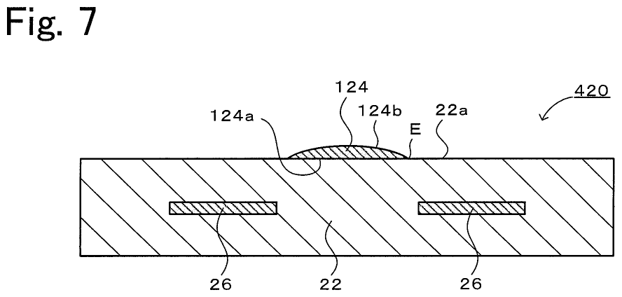

In the above-described embodiment, as in the case of a charge generation element 320 illustrated in FIG. 5, a discharge electrode 124 may be employed instead of the discharge electrode 24. In FIG. 5, the same structural elements as those in the above-described embodiment are denoted by the same reference numerals. The discharge electrode 124 has a flat base surface 124a and a bulging surface 124b having a shape bulging from the base surface 124a toward the outside of the dielectric layer 22 in a cross section taken along the thickness direction. The base surface 124a is flush with the front surface 22a of the dielectric layer 22. At the edge E of the discharge electrode 124, the angle θ between the base surface 124a and the bulging surface 124b is from 5° to 45°, and preferably from 10° to 30°. In these ways, also, substantially the same advantageous effects as those of the above-described embodiment can be obtained. In this configuration including the discharge electrode 124, as illustrated in FIG. 6, the front surface 22a of the dielectric layer 22 and the bulging surface 124b of the discharge electrode 124 may be covered by an insulative protection layer 127. The protection layer 127 prevents damage and oxidation of the discharge electrode 124 due to discharge deterioration, and also plays a role to prevent the dielectric layer 22 from taking up moisture. The bulging surface 124b of the discharge electrode 124 is more gently sloped compared with a rectangular cross-section discharge electrode 524 (see FIG. 9), and thus the protection layer 127 can be formed relatively well by, for example, printing. In addition, in a configuration including the discharge electrode 124, as in the case of a charge generation element 420 illustrated in FIG. 7, the ground electrodes 26 may be embedded in the dielectric layer 22. In FIG. 7, the same structural elements as those in the above-described embodiment are denoted by the same reference numerals. In these ways, also, substantially the same advantageous effects as those of the above-described embodiment can be obtained.

In the above-described embodiment, the discharge electrode 24 and the ground electrodes 26 are bonded to the dielectric layer 22 by sintering; however, the discharge electrode 24 and the ground electrodes 26 may also be bonded to the dielectric layer 22 with an inorganic adhesive (for example, glass or the like).

### Second Embodiment

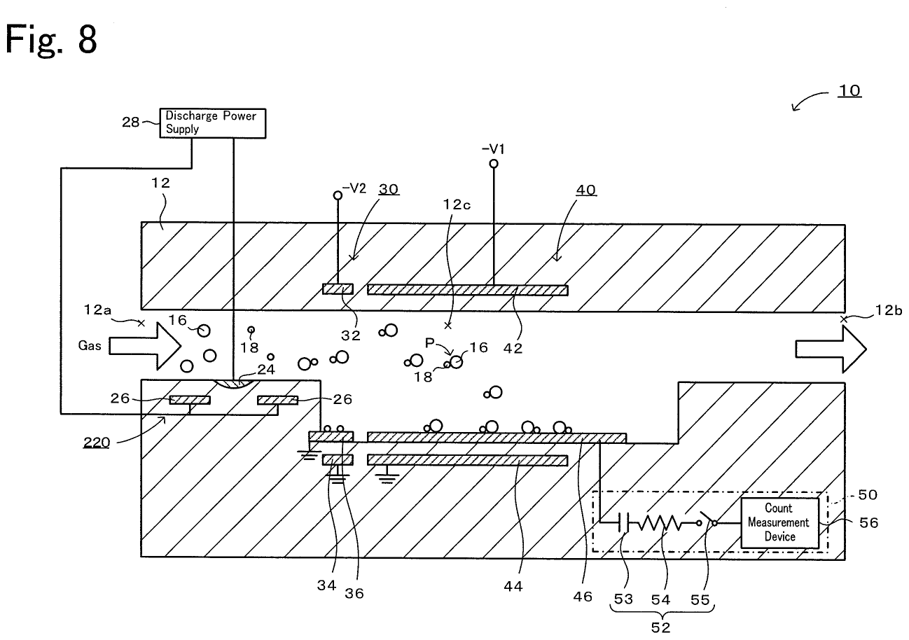

A fine-particle count detector 10 using the charge generation element 220 described above will be described in the following with reference to the drawings. FIG. 8 is a cross section illustrating a schematic configuration of the fine-particle count detector 10.

The fine-particle count detector 10 measures the number of fine-particles contained in gas (for example, car exhaust gas). As illustrated in FIG. 8, the fine-particle count detector 10 has the charge generation element 220, an excess charge eliminator 30, a collector 40, and a detector body 50 in an air pipe 12 made of a ceramic material. The air pipe 12 has a gas inlet 12a, from which gas is drawn into the air pipe 12, and a gas outlet 12b, from which the gas having passed through the air pipe 12 is exhausted.

The charge generation element 220 is configured as illustrated in FIG. 4, and is provided on the side near the gas inlet 12a of the air pipe 12. Thus, a detailed description of the charge generation element 220 will be omitted. Note that, in this case, the inside wall of the air pipe 12, which is made of a ceramic material, is used as the dielectric layer 22 illustrated in FIG. 4. The discharge electrode 24 and the ground electrodes 26 are connected to a discharge power supply 28, which applies a voltage Vp (for example, a pulse voltage or the like). A potential difference occurs between the electrode 24 and the electrodes 26 as a result of application of the voltage Vp therebetween, and causes a discharge. Gas passes through this discharged space, and as a result electric charges 18 (in this case, negative charges) are added to fine-particles 16 in the gas, so that charged fine-particles P are obtained.

The excess charge eliminator 30 eliminates excess electric charges 18, which are not added to the fine-particles 16, among the electric charges 18 generated at the charge generation element 220, and is provided between the charge generation element 220 and the collector 40 in a hollow section 12c in the air pipe 12. The excess charge eliminator 30 has a pair of elimination field generating electrodes (an application electrode 32 and a ground electrode 34) and an eliminating electrode 36. The application electrode 32 and the ground electrode 34 are embedded at positions facing each other in the wall of the air pipe 12. The application electrode 32 is an electrode having a negative potential of −V2. The absolute value of the negative potential −V2 is smaller than the absolute value of a negative potential −V1 of the collector 40, which will be described later, by an order of magnitude or greater. The ground electrode 34 is an electrode connected to the ground. The eliminating electrode 36 is arranged between the application electrode 32 and the ground electrode 34, and is exposed to the wall of the hollow section 12c in which the ground electrode 34 is embedded. As a result, a weak electric field occurs between the application electrode 32 and the ground electrode 34 of the excess charge eliminator 30. Thus, the excess electric charges 18, which are not added to the fine-particles 16, among the electric charges 18 generated at the charge generation element 220 are attracted to the ground electrode 34 by this weak electric field, captured by the eliminating electrode 36, and then dumped to the ground.

The collector 40 is a device that collects the charged fine-particles P, and is provided in the hollow section 12c in the air pipe 12. The collector 40 has a pair of collection field generating electrodes (an application electrode 42 and a ground electrode 44) and a collection electrode 46. The application electrode 42 and the ground electrode 44 are embedded at positions facing each other in the wall of the air pipe 12. The application electrode 42 is an electrode having a negative potential of −V1. The level of the negative potential −V1 is on the order of a minus millivolt (mV) to a minus few tens of volts (V). The ground electrode 44 is an electrode connected to the ground. The collection electrode 46 is arranged between the application electrode 42 and the ground electrode 44, and is exposed to the wall of the hollow section 12c in which the ground electrode 44 is embedded. As a result, an electric field directed from the ground electrode 44 to the application electrode 42 is generated in the hollow section 12c. Thus, the charged fine-particles P (negatively charged) that have entered the hollow section 12c are attracted to the ground electrode 44 by the electric field being generated and are collected by the collection electrode 46, which is provided on the way to the ground electrode 44.

The detector body 50 corresponds to a detection device according to the present invention, and has a series circuit portion 52 and a count measurement device 56. The series circuit portion 52 is provided between the collection electrode 46 and the count measurement device 56. In the series circuit portion 52, from the side where the collection electrode 46 is provided, a capacitor 53, a resistor 54, and a switch (preferably a semiconductor switch) 55 are connected in series. The count measurement device 56 is a device that measures the number of fine-particles 16 on the basis of the charge amount of the charged fine-particles P collected by the collection electrode 46. When the switch 55 is turned on, a current based on the electric charges 18 of the charged fine-particles P collected by the collection electrode 46 is transferred as a transient response to the count measurement device 56 via a series circuit including the capacitor 53 and the resistor 54. The count measurement device 56 measures the value of the current using an ammeter, and calculates the number of fine-particles 16 on the basis of the current value.

Next, examples of the use of the fine-particle count detector 10 will be described. In a case where fine-particles contained in car exhaust gas are measured, the fine-particle count detector 10 is installed in an exhaust pipe of an engine. In this case, the fine-particle count detector 10 is installed such that exhaust gas is drawn from the gas inlet 12a of the fine-particle count detector 10 into the air pipe 12 and is exhausted from the gas outlet 12b.

The fine-particles 16 contained in the exhaust gas drawn from the gas inlet 12a into the air pipe 12 assume the electric charges 18 (in this case, negative charge) generated by a discharge at the charge generation element 220, become the charged fine-particles P, and thereafter enter the hollow section 12c. Upon reaching the collector 40, the charged fine-particles P that are in the hollow section 12c are attracted to the ground electrode 44 and collected by the collection electrode 46 installed on the way to the ground electrode 44. The excess electric charges 18, which are not added to the fine-particles 16, among the electric charges 18 generated at the charge generation element 220 are attracted to the ground electrode 34 by this weak electric field, captured by the eliminating electrode 36, and then dumped to the ground. Thus, no excess electric charges 18 are collected by the collection electrode 46 of the collector 40. The current based on the electric charges 18 of the charged fine-particles P adhered to the collection electrode 46 is transferred as a transient response to the count measurement device 56 via the series circuit including the capacitor 53 and the resistor 54.

Relationships between a current I and a charge amount q are I=dq/(dt) and q=∫Idt. Thus, the count measurement device 56 obtains the integral (an accumulated charge amount) of the current value by integrating (accumulating) the current value over a period during which the switch 55 is on (a switch on period). After the switch on period has elapsed, the total number of electric charges (the number of collected charges) is obtained by dividing the accumulated charge amount by elementary charge. The number of fine-particles 16 adhered to the collection electrode 46 over a fixed period of time (for example, 5 to 15 seconds) can be obtained by dividing the number of collected charges by the average number of charges added to one fine-particle 16. Over a predetermined period (for example, from 1 to 5 minutes), the count measurement device 56 repeatedly calculates and accumulate the number of fine-particles 16 for the fixed period of time. As a result, the count measurement device 56 can calculate the number of fine-particles 16 adhered to the collection electrode 46 over the predetermined period. In addition, the use of a transient response via the capacitor 53 and the resistor 54 makes it possible to measure even a small current, and thus the number of fine-particles 16 can be detected with high accuracy. In the case of a very small current at a picoampere (pA) level or a nanoampere (nA) level, measurement of a very small current becomes possible, for example, by increasing the time constant by using a resistor 54 having a large value.

With the fine-particle count detector 10 described above in detail and according to the present embodiment, since the charge generation element 220 is used, the voltage between the discharge electrode 24 and the ground electrodes 26 for generating electric charge can be lowered. In addition, the base surface 24a, which is exposed to the outside, of the discharge electrode 24 is flush with the front surface of the dielectric layer (that is, the inside wall of the air pipe 12), and thus foreign matters such as the fine-particles 16 are less likely to accumulate.

Note that the present invention is not limited to the above-described embodiment at all. Needless to say, the present invention can be carried out in various modes without departing from the technical scope of the present invention.

For example, the charge generation element 220 is employed in the above-described embodiment; however, the charge generation element 420 described above (see FIG. 7) may be employed. In this case, also, the voltage between the discharge electrode 124 and the ground electrodes 26 for generating electric charge can be lowered. In addition, since the bulging surface 124b, which is exposed to the outside, of the discharge electrode 124 becomes thinner toward its edge E, foreign matters such as the fine-particles 16 are less likely to accumulate, compared with the discharge electrode 524 illustrated in FIG. 9. Note that the above-described charge generation element 20, 120, or 320 may also be employed instead of the charge generation element 220.

The excess charge eliminator 30 is provided in the above-described embodiment; however, the excess charge eliminator 30 may be omitted.

In the above-described embodiment, the case where the number of negatively charged fine-particles P is measured has been described; however, even in the case of the positively charged fine-particles P, the number of fine-particles 16 can also be measured similarly. In a case where the number of positively charged fine-particles P is measured, for example, a positive voltage is applied to the application electrode 42 and the collection electrode 46 may collect the charged fine-particles P.

In the above-described embodiment, the number of fine-particles is detected on the basis of the current that flows when the charged fine-particles P are collected by the collection electrode 46; however, the number of fine-particles in gas may also be detected on the basis of the difference between the total amount of electric charge generated at the charge generation element 20 and the amount of electric charge collected by the eliminating electrode 36 (that is, the electric charges 18 that are not added to the fine-particles 16).

### EXAMPLES

### Example 1

The charge generation element 220 described above (see FIG. 4) was manufactured as in the following. First, a polyvinyl butyral resin (PVB) serving as a binder, bis phthalate (2-ethylhexy) (DOP) serving as a plasticizer, and xylene and 1-butanol serving as a solvent were added to alumina powder, and the mixture was mixed by a ball mill for 30 hours to prepare slurry for green sheet forming. This slurry underwent a vacuum degassing treatment to adjust its viscosity to 4000 cps, and thereafter a green sheet was manufactured by a doctor blade device such that the green sheet had a thickness of 200 μm after firing. The green sheet was cut to manufacture two green sheets. Screen printing was performed on one of the two green sheets such that, as ground electrodes, a film formed after firing Pt paste had a thickness of 5 μm, and the Pt paste was dried at 120° C. for 10 minutes. For the other green sheet, a depression portion was formed by pressing, against a position on the green sheet where a discharge electrode was to be formed, a fluororesin member with a projection portion having the same shape as the discharge electrode such that the depression portion had a depth of 5 μm after firing. The fluororesin member was used in terms of release characteristics for green sheets. The shape of the discharge electrode in the thickness direction can be controlled depending on the shape of the fluororesin member, and the fluororesin member with the projection portion having the same shape as the discharge electrode whose angle θ described above was 30° was used in the present example. Screen printing was performed in the depression portion such that, as the discharge electrode, a film formed after firing Pt paste had a thickness of 5 μm and did not extend off the depression portion, and the Pt paste was dried at 120° C. for 10 minutes. The green sheet on which the ground electrodes were formed and the green sheet on which the discharge electrode was formed were superposed with each other such that the ground electrodes were provided inside and the discharge electrode was provided on an external surface. Integral firing was performed at 1450° C. for 2 hours in a state in which a porous alumina setter was placed on the surface where the discharge electrode was formed. The reason why the porous alumina setter was used is to prevent the substrate from warping due to integral firing, to control the angle between both ends of the discharge electrode in the thickness direction, and to prevent the green sheet and the discharge electrode from adhering to the setter.

As a result, the green sheet was fired to become a ceramic substrate, and a charge generation element (see the charge generation element 220 in FIG. 4) was obtained in which the discharge electrode was provided on one surface of the ceramic substrate and the ground electrodes were provided in the ceramic substrate. The angle θ between the base surface and the bulging surface was 30° at the edge of the discharge electrode.

### Example 2

The charge generation element 420 described above (see FIG. 7) was manufactured in accordance with the following procedure. First, a polyvinyl butyral resin (PVB) serving as a binder, bis phthalate (2-ethylhexy) (DOP) serving as a plasticizer, and xylene and 1-butanol serving as a solvent were added to alumina powder, and the mixture was mixed by a ball mill for 30 hours to prepare slurry for green sheet forming. This slurry underwent a vacuum degassing treatment to adjust its viscosity to 4000 cps, and thereafter a green sheet was manufactured by a doctor blade device such that the thickness of the green sheet after firing became 200 μm. The green sheet was cut to manufacture two green sheets. Screen printing was performed on one of the two green sheets such that, as ground electrodes, a film formed after firing Pt paste had a thickness of 5 μm, and the Pt paste was dried at 120° C. for 10 minutes. The other green sheet and the green sheet on which the ground electrodes were formed were superposed with each other such that the ground electrodes were provided inside and the discharge electrode was provided on an external surface, and integral firing was performed at 1450° C. for 2 hours. On the ceramic substrate obtained in this way, screen printing was performed such that, as the discharge electrode, the central portion of a film formed after firing Pt paste had a thickness of 5 μm and, at the edge, the angle between a flat base surface and a bulging surface bulging toward the outside was 30°. The Pt paste was dried at 120° C. for 10 minutes. In order to obtain an angle of 30° at the edge, the print pressure of the screen printer was increased from 0.2 MPa, which is a conventional condition, to 0.25 MPa, and also the percentage of texanol, which is an organic solvent, contained in Pt paste, was raised from 16 mass percent, which is a conventional percentage, to 21 mass percent. The side on which the discharge electrode was formed was placed to face upward, and integral firing was performed at 1450° C. for 2 hours.

As a result, the green sheet was fired to become a ceramic substrate, and a charge generation element (see the charge generation element 420 in FIG. 7) was obtained in which the discharge electrode was provided on one surface of the ceramic substrate and the ground electrodes were provided in the ceramic substrate. The angle θ between the base surface, which was flush with a surface of the ceramic substrate, and the bulging surface was 30° at the edge of the discharge electrode.

### Comparative Example 1

The charge generation element 520 described above (see FIG. 9) was manufactured in accordance with the following procedure. First, a polyvinyl butyral resin (PVB) serving as a binder, bis phthalate (2-ethylhexy) (DOP) serving as a plasticizer, and xylene and 1-butanol serving as a solvent were added to alumina powder, and the mixture was mixed by a ball mill for 30 hours to prepare slurry for green sheet forming. This slurry underwent a vacuum degassing treatment to adjust its viscosity to 4000 cps, and thereafter a green sheet was manufactured by a doctor blade device such that the green sheet had a thickness of 200 μm after firing. The green sheet was cut, and integral firing was performed at 1450° C. for 2 hours. As a result, a ceramic substrate (a dielectric layer), which was a constituent member of the charge generation element, was manufactured. In addition, a SUS316 sheet member having a thickness of 20 μm was cut by laser processing so as to match the size of each of the discharge electrode and the ground electrodes, and discolored portions caused by heat and burrs were removed by chemical polishing. A charge generation element (see the charge generation element 520 illustrated in FIG. 9) was obtained by bonding the discharge electrode and ground electrodes obtained in this way to the ceramic substrate using an adhesive.

[Evaluation of Charge Generation Element]

Evaluation tests were performed on the charge generation elements manufactured in Example 1, Example 2, and Comparative Example 1. As an evaluation method, a discharge voltage in a case where the density of ions, which were an example of charge, became 1×10⁶ (pieces/cc) corresponding to class 6, the highest class, in JIS B9929 was measured. The waveform of a voltage to be applied to the charge generation elements was a pulse wave having a pulse width of 50 μsec and a period of 1 msec. As a measurement procedure, pulse waves were generated by a function generator (manufactured by Tektronix, Inc.), a voltage waveform obtained by performing high-voltage amplification using a high-voltage amplifier (manufactured by TREK, INC.) was applied to the charge generation elements, and the densities of ions generated from the charge generation elements were measured by an ion counter (manufactured by TAIEI Engineering Co., Ltd). The density of ions was measured while the voltage was being increased, and the voltage at the time when the density of ions was 1×10⁶ (pieces/cc) was recorded. The polarity of the applied voltage was positive, and an offset voltage was superposed such that the base line of the voltage waveform became 0 V. Consequently, the polarity of ions for which the density of ions was measured was also positive. The discharge voltage at the time when the ion density was 1×10⁶ (pieces/cc) was 2.1 kV for both Example 1 and Example 2, in contrast to 2.6 kV for Comparative Example 1. This result shows that the discharge voltage was reduced by 0.5 kV.

The present invention is not limited to the above-described embodiment, and various embodiments are possible within the technical scope of the present invention.

The present application claims priority on the basis of the Japanese Patent Application No. 2017-45635 filed on Mar. 10, 2017, the entire contents of which are incorporated herein by reference.

What is claimed is:

1. A charge generation element comprising:
a discharge electrode on one surface of a dielectric layer; and a ground electrode on the other surface or in the inside of the dielectric layer, the charge generation element generating electric charge as a result of a discharge upon application of a voltage between the discharge electrode and the ground electrode,
wherein the discharge electrode has a flat base surface and a bulging surface having a shape bulging from the base surface, and an angle θ between the base surface and bulging surface is from 5° to 45° at an edge of the discharge electrode.

2. The charge generation element according to claim 1,
wherein the angle θ is from 10° to 30°.

3. The charge generation element according to claim 1,
wherein the dielectric layer is made of a ceramic material, and the discharge electrode and the dielectric layer are bonded together by sintering or with an inorganic adhesive.

4. The charge generation element according to claim 1,
wherein the base surface of the discharge electrode is flush with the one surface of the dielectric layer, and the bulging surface bulges from the base surface toward the inside of the dielectric layer.

5. The charge generation element according to claim 4,
wherein the base surface is coated by an insulative protection layer.

6. The charge generation element according to claim 1,
wherein the base surface of the discharge electrode is flush with the one surface of the dielectric layer, and the bulging surface bulges from the base surface toward the outside of the dielectric layer.

7. The charge generation element according to claim 6,
wherein the bulging surface is coated by an insulative protection layer.

8. A fine-particle count detector comprising:
the charge generation element according to claim 1, the charge generation element adding electric charge to fine-particles in gas drawn into an air pipe; and
a detection device that detects the number of fine-particles in the gas on the basis of a charge amount of fine-particles to which the electric charge is added or a charge amount that is not added to the fine-particles.
